(19) United States
(12) Patent Application Publication
(10) Pub. No.: US 2007/0056639 A1
(43) Pub. Date: Mar. 15, 2007

(54) Aspirator for a shower fitting

(76) Inventor: Gerald J. McNerney, Noblesville, IN (US)

Correspondence Address: BAKER & DANIELS LLP, 300 NORTH MERIDIAN STREET, SUITE 2700, INDIANAPOLIS, IN, 46204, US

(21) Appl. No.: 11/227,765

(22) Filed: Sep. 15, 2005

(51) Int. Cl. F16K 11/20

(52) U.S. Cl. 137/597

(57) ABSTRACT

An aspirator configured to be received within a shower fitting for generating a negative pressure in response to water flow.

### BACKGROUND AND SUMMARY OF THE INVENTION

Conventional shower installations are known to include both a tub spout and a shower head. The tub spout and the shower head are often connected to the same valve assembly. Such shower installations often further include a diverter valve coupled to the tub spout, so that in a first position the diverter valve allows water to exit through the tub spout and in a second position the diverter valve closes off the outlet through the tub spout, thereby forcing water up through a shower riser to the shower head.

A common problem with such an arrangement between the tub spout and the shower head is that there is no positive shut off to the shower head. Even when the diverter valve is positioned to direct water through the tub spout, sufficient pressure may build up within the shower riser so that water leaks through the shower head.

Previous attempts to prevent leakage to the shower head have provided an aspirator insert, sometimes called an ejector, which uses the well-known venturi effect to create a vacuum in the shower head when water is flowing out of the tub spout. However, in order to gain the desired result from most such venturi systems, the flow rate of water from the valve assembly is substantially reduced. In other words, the aspirator essentially reduces the effective flow rate from the tub spout.

According to an illustrative embodiment of the present invention, a shower fitting includes a first outlet, a second outlet, and a bore having an inner surface and in fluid communication with the first outlet and the second outlet. At least one inlet is provided in fluid communication with the bore. An aspirator includes a body received within the bore. The body includes a first end, a second end, an inner passageway extending between the first end and the second end, and an outer surface positioned in spaced relation to the inner surface of the bore. An outer passageway is defined intermediate the outer surface of the body and the inner surface of the bore. The outer passageway includes a sealed first end, an open second end, a first cross-sectional area proximate the sealed first end, and a second cross-sectional area proximate the open second end. The first cross-sectional area is greater than the second cross-sectional area. The outer passageway opens to the bore proximate the open second end, the bore having a cross-sectional area greater than the second cross-sectional area of the outer passageway, such that negative pressure is exerted on the inner passageway by fluid flow through the outer passageway to the second outlet.

According to a further illustrative embodiment, an aspirator is configured to be received within a bore of a shower fitting. The aspirator includes a body having a first end, a second end, an inner passageway extending axially between the first end and the second end, and an outer surface extending radially outwardly as the outer surface extends axially in a direction from the first end toward the second end. A deflector is coupled to the second end of the body and includes an outer surface extending radially inwardly as the outer surface extends axially in a direction away from the second end of the body. An opening is defined between the second end of the body and the deflector, the opening being in fluid communication with the inner passageway.

According to another illustrative embodiment, an aspirator is configured to be received within a bore of a shower fitting. The aspirator includes a body having a first end, a second end, and an inner passageway extending axially between the first end and the second end. The body includes a frusto-conical portion positioned intermediate the first end and the second end. An end wall extends radially outwardly from the first end of the body and is configured to be sealingly received within the bore.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a perspective view, with a partial cut away thereof, of a shower fitting according to an illustrative embodiment of the present disclosure;

FIG. 2 is a cross-sectional view taken along line 2-2 of FIG. 1;

FIG. 3 is a cross-sectional view taken along line 3-3 of FIG. 1;

FIG. 4 is a cross-sectional view taken along line 4-4 of FIG. 1;

FIG. 5 is a diagrammatic view of a shower installation including the illustrative shower fitting of FIG. 1;

FIG. 6 is a perspective view of an aspirator according to an illustrative embodiment of the present disclosure;

FIG. 7 is detail view of a deflector coupled to a body of the aspirator of FIG. 6;

FIG. 8 is an exploded perspective view of the aspirator of FIG. 6;

FIG. 9 is a cross-sectional view taken along line 9-9 of FIG. 6; and

FIG. 10 is a cross-sectional view taken along line 10-10 of FIG. 6.

### DESCRIPTION OF INVENTION

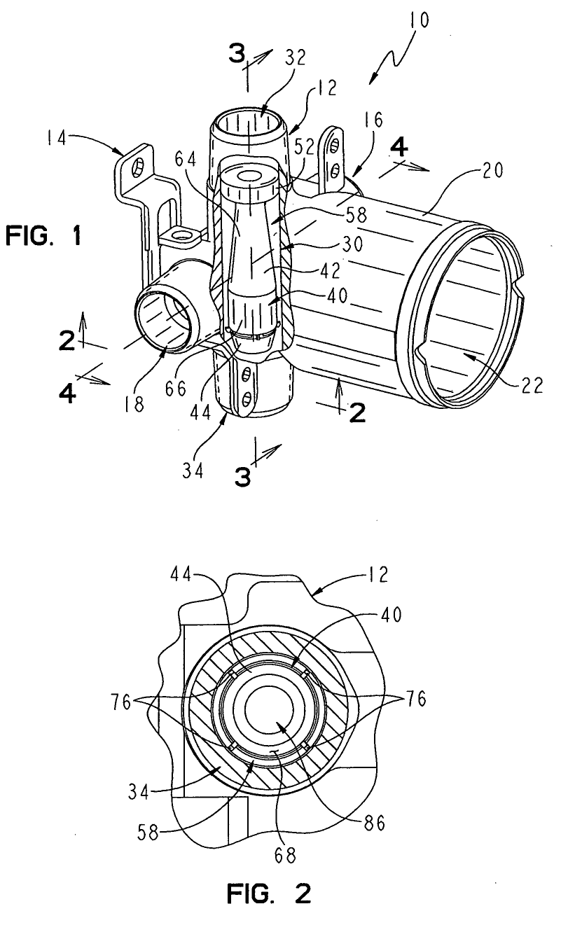

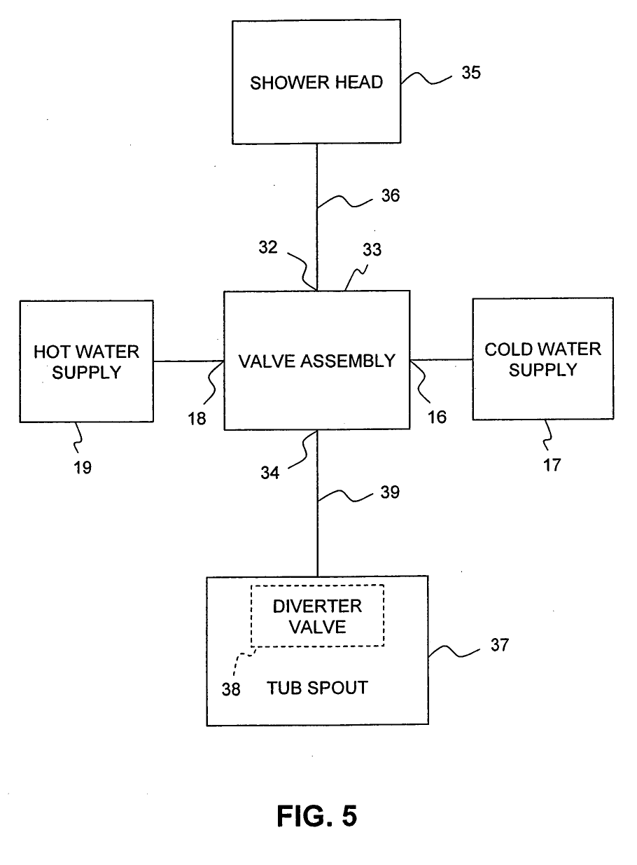

Referring initially to FIGS. 1-4, a shower fitting 10 is illustrated as including a valve body 12 coupled to a mounting bracket 14. The valve body 12 includes a tubular cold water inlet 16, which is configured to be fluidly coupled to a conventional cold water supply 17 (FIG. 5), and a tubular hot water inlet 18, which is configured to be fluidly coupled to a conventional hot water supply 19 (FIG. 5). The valve body 12 further illustratively includes a cylindrical wall 20 defining a mixing chamber 22, which upon final assembly is configured to receive a conventional valving member or cartridge (not shown), thereby defining a valve assembly 33 (FIG. 5). Conventional valving cartridges are disclosed in U.S. Pat. No. 4,901,750 to Nicklas et al. and U.S. Pat. No. 5,355,906 to Marty et al., the disclosures of which are expressly incorporated by reference herein.

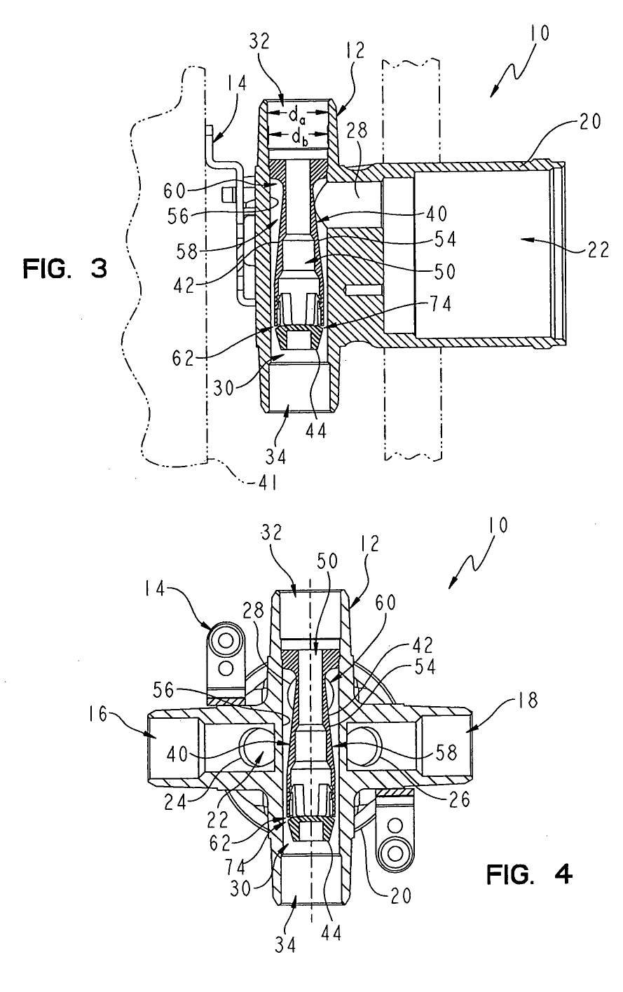

With reference to FIG. 4, a cold water connecting port 24 provides fluid communication between the cold water inlet 16 and the mixing chamber 22. Likewise, a hot water connecting port 26 provides fluid communication between the hot water inlet 18 and the mixing chamber 22. As shown in FIGS. 3 and 4, a mixed water connecting port 28 provides fluid communication between the mixing chamber 22 and an outlet bore 30. Illustratively, the outlet bore 30 is disposed perpendicular to the inlets 16 and 18. The outlet bore 30 provides fluid communication between a first outlet 32 and a second outlet 34. Illustratively, as shown in FIG. 5, the first outlet 32 is configured to be fluidly coupled to a conventional shower head 35 through a shower riser 36. The second outlet 34 is configured to be fluidly coupled to conventional tub spout 37, illustratively including a diverter valve 38, through a delivery pipe 39. Such an arrangement is detailed in U.S. Pat. No. 4,899,397 to Crawford et al., the disclosure of which is expressly incorporated by reference herein.

As shown in FIG. 3, the mounting bracket 14 is configured to be secured to a wall support, typically a stringer 41, which is a horizontally mounted piece of wood positioned between two studs (not shown). The mounting bracket 14 may be of the type disclosed in U.S. patent application Ser. No. 11/107,616, filed Apr. 15, 2005, the disclosure of which is expressly incorporated by reference herein.

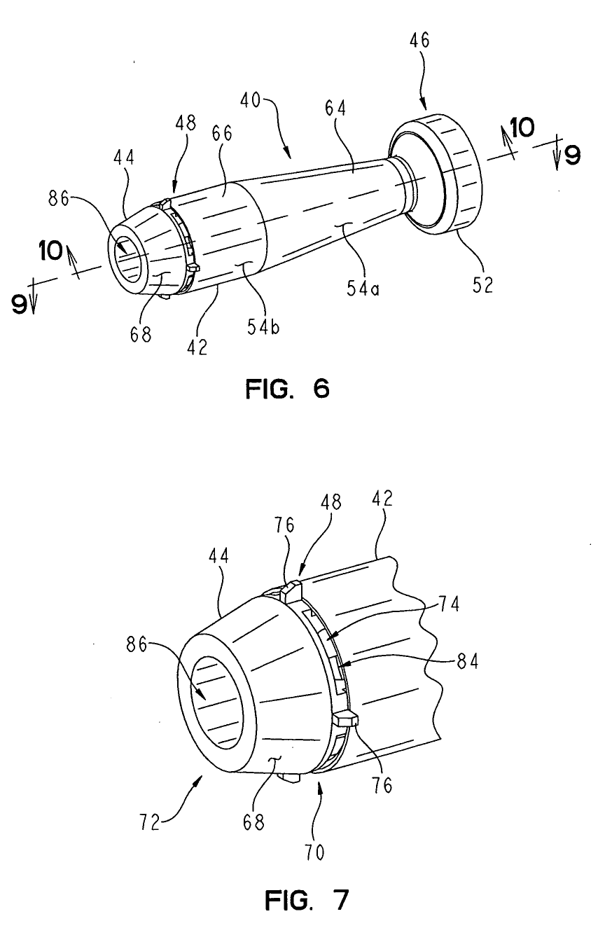

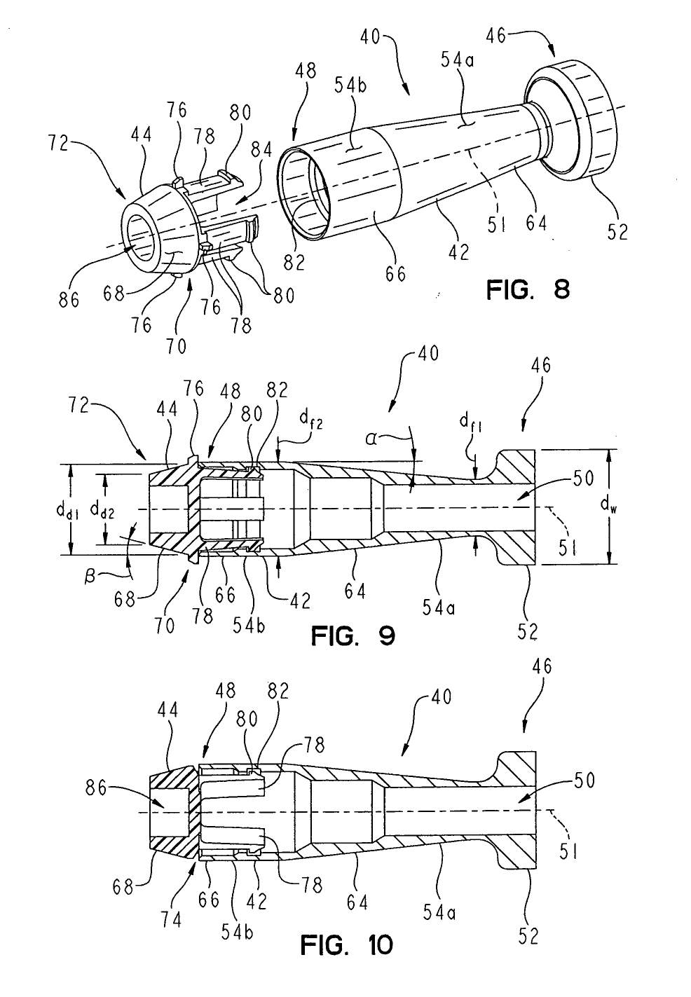

As shown in FIGS. 1-4, an aspirator 40 is positioned within the bore 30 intermediate the first outlet 32 and the second outlet 34. With reference to FIGS. 5-10, the aspirator 40 includes an aspirator body 42 and a deflector 44 releasably coupled to the body 42. The body 42 includes a first end 46 and a second end 48. An inner passageway 50 extends axially along a longitudinal axis 51 between the first end 46 and the second end 48. An end wall or flange 52 extends radially outwardly from the first end 46 of the body 42 and is configured to be sealingly received within the bore 30. More particularly, the end wall 52 is illustratively press fit within the bore 30 and, as such, secures the aspirator 40 therein. In one illustrative embodiment, the end wall 52 has an outer diameter d_{w} (FIG. 9) greater than an inner diameter d_{b} of the bore 30 (FIG. 3), thereby providing an interference fit around the circumference of the end wall 52. Further, the outlets 32 and 34 illustratively have inner diameters dₒ (FIG. 3) greater than the outer diameter d_{w} of the end wall 52, thereby providing clearance therebetween to assist during assembly.

With reference to FIGS. 3 and 4, an outer surface 54 of the body 42 is positioned in spaced relation to an inner surface 56 of the bore 30. An outer passageway 58 is defined intermediate the outer surface 54 of the body 42 and the inner surface 56 of the bore 30, wherein the outer passageway 58 has a sealed first end 60 and an open second end 62. The outer passageway 58 opens to the full-width bore 30 proximate the open second end 62 immediately after the deflector 44. The body 42 includes a frusto-conical portion 64 and an extension portion 66. The outer surface 54a of the frusto-conical portion 64 gradually expands radially outwardly as the surface 54a extends in a direction from proximate the first end 46 to the second end 48. Illustratively, the frusto-conical portion 64 has a first outer diameter d_{f1} proximate the first end 46 that is less than a second outer diameter d_{f2} proximate the second end 48 (FIG. 9).

In one illustrative embodiment, the first outer diameter d_{f1} is approximately 0.3 inches and the second outer diameter d_{f2} is approximately 0.5 inches. The bore 30 illustratively has a substantially consistent inner diameter d_{b} of 0.585 from proximate the first end 60 to proximate the second end 62. As such, the outer passageway 58 has a first cross-sectional area proximate the first end 46 that is approximately 0.198 square inches, and has a second cross-sectional area proximate the second end 48 that is approximately 0.073 square inches. The reduction in cross-sectional area of the outer passageway 58 from the first end 60 to the second end 62 causes the velocity of the water to increase. As the velocity of the water increases from the first end 60 to the second end 62, the pressure of the water decreases. Conversely, when the water travels past the second end 62 and the cross-sectional area of the water flow path increases, the velocity decreases and the pressure increases. However, proximate the second end 48 of the body 42 (e.g., the open second end 62 of the outer passageway 58), a localized but significant decrease in pressure occurs. This localized drop in pressure is a result of the venturi effect in combination with an abrupt expansion in flow area.

The frusto-conical portion 64 provides for a gradual increase in the outer diameter of the body 42, and a corresponding gradual decrease in the cross-sectional area of the outer passageway 58. In the illustrative embodiment, the approximate 0.2 inch increase in the outer diameter of the body 42, and the corresponding approximate 0.125 decrease in the cross-sectional area of the outer passageway 58, occurs over an axial length of approximately 1 inch. The resulting slope angle α of the outer surface 54a of the frusto-conical portion 64 is approximately 16 degrees from the longitudinal axis 51 (FIG. 9). The gradual change in outer diameter of the body 42 assists in removing turbulence from the water, thereby providing a more laminar flow.

The extension portion 66 of the body 42 has a substantially cylindrical outer surface 54b. More particularly, the extension portion 66 includes a substantially consistent outer diameter equal to the second outer diameter d_{f2} of the frusto-conical portion 64 (i.e., approximately 0.5 inches), thereby providing a substantially consistent cross-sectional area of 0.073 square inches for the outer passageway 58 to the second end 48 of the body 42. The extension portion 66 has a length of approximately 0.5 inches, such that the axial distance from the first end 46 to the second end 48 of the body 42 is approximately 1.5 inches. The axial length of the body 42 and, in turn, of the outer passageway 58 provides sufficient travel distance to further assist in removing turbulence from the water and thereby providing for increased laminar flow passing through the open second end 62 of the outer passageway 58 at a high speed. This results in a venturi effect for providing a negative pressure within the shower riser 36, as further detailed herein.

With further reference to FIGS. 7-10, the deflector 44 has a tapered outer surface 68 that extends radially inwardly as the outer surface 68 extends from a first end 70 to a second end 72, in a direction axially away from the second end 48 of the body 42. In the illustrative embodiment as shown in FIG. 9, the deflector 44 has a first outer diameter d_{d1} proximate the first end 70 which is approximately 0.48 inches, slightly smaller than the second outer diameter d_{f2} of the body 42. The deflector 44 has a second outer diameter d_{d2} proximate the second end 72 which is approximately equal to 0.38 inches. As such, the outer diameter decreases from approximately 0.48 inches (d_{d1}) to 0.38 inches (d_{d2}) over an axial length of approximately 0.2 inches. The slight increase in cross-sectional area for water flow from the second end 48 of the body 42 to the first end 70 of the deflector 44 provides for a smooth transition of the water as it exits the outer passageway 58. The slope angle β of the outer surface 68 is approximately 15 degrees from the longitudinal axis 51.

As shown in FIG. 7, the deflector 44 is axially spaced from the of the body 42 to define an opening 74 therebetween. The opening 74 is in fluid communication with the outer passageway 58 and the inner passageway 50 (FIG. 3). A plurality of circumferentially-spaced tabs 76 extend radially outwardly from proximate the first end 70 of the outer surface 68 and are configured to facilitate axial and radial alignment of the deflector 44 to facilitate fluid flow to the opening 74. More particularly, the tabs 76 are configured to maintain predetermined axial spacing between the deflector 44 and the body 42, and to maintain predetermined radial spacing between the deflector 44 and the bore 30. With reference to FIGS. 8 and 9, a plurality of angularly spaced resilient legs 78 extend axially in a direction from the first end 70 of the outer surface 68 toward the body 42. The legs 78 each include a protuberance or catch 80 configured to be received within an annular groove 82 formed within the inner passageway 50 of the body 42. A plurality of passages 84 are formed between the legs 78 and are in fluid communication with the opening 74 and the inner passageway 50 (FIGS. 3 and 4).

The outer surface 68 of the deflector 44 enhances water flow by providing a smooth transition from the second end 48 of the body 42 to the second outlet 34. The outer surface 68 prevents water from sharply curving around the second end 48 of the body 42, thereby assisting to prevent the addition of turbulence into the water flow at the low pressure area adjacent to the second end 62.

At the second end 72 of the deflector 44, the outer passageway 58 opens into the full-width bore 30 proximate the second outlet 34. At this location, the water flows into a cross-sectional area of approximately 0.2688 square inches, based upon the inner diameter of the bore 30 of approximately 0.585 inches. The cross-sectional area increases from approximately 0.0725 square inches to approximately 0.2688 square inches, thereby resulting in a substantial decrease in water flow velocity and pressure. As noted above, the venturi effect in combination with an abrupt expansion in flow area results in a localized but significant decrease in water pressure proximate the second end 48 of the body 44. This pressure drop causes a vacuum to be pulled through the opening 74, passages 84, inner passageway 50, shower riser 36, and shower head 35.

Illustratively, the body 42 is formed of a durable metal, such as brass, and the deflector 44 is formed of a thermoplastic. However, it should be appreciated that the body 42 and the deflector 44 may be formed of other suitable materials. For example, the deflector 44 may be stamped from a metal, such as copper. Further, the body 42 and the deflector 44 may be formed as a single integral piece. The deflector 44, if injection molded from a thermoplastic, may include a recess 86 (FIG. 7) to provide substantially uniform wall thickness for improving the molding process.

In operation, cold water enters through the cold water inlet 16, while hot water enters through the hot water inlet 18. The cold water is supplied to the mixing chamber 22 through the cold water connecting port 24, while the hot water is supplied to the mixing chamber 22 through the hot water connecting port 26. The cold water and the hot water are combined, as appropriate, in the mixing chamber 22 and then supplied to the mixed water connecting port 28 through operation of the valve cartridge of the valve assembly 33.

The mixed water passes through the connecting port 28 to the outer passageway 58 defined between the body 42 and the bore 30. The water travels axially from proximate the sealed first end 60 to the open second end 62. The frusto-conical portion 64 results in a reduction of cross-sectional area of the outer passageway 58 causing increased velocity and reduced pressure of the water. The gradual reduction in cross-sectional area and the overall length of the outer passageway 58 from the first end 60 to the second end 62 assists in removing turbulence from the water flow, providing more laminar characteristics. As the water flows past the second end 48 of the body 42 and over the deflector 44 to the second outlet 34, the dramatic increase in the cross-sectional area of the bore 30 causes a reduction in water velocity and an increase in water pressure. The venturi effect in combination with an abrupt expansion in flow area causes a localized drop in pressure resulting in a negative pressure or vacuum pulling air through the opening 74, the passages 84, and the inner passageway 50 as water flows through the second outlet 34 and the tub spout 37. The vacuum is likewise pulled through the first outlet 32, the shower riser 36, and the shower head 35 to prevent undesired water leakage therefrom.

When water is desired at the shower head 35, the diverter valve 38 is placed in the closed position and water then backs up through the opening 74, the passages 84, and the inner passageway 50. Water continues to flow through the first outlet 32, up through the shower riser 36, and then passes through the shower head 35.

Although the invention has been described in detail with reference to certain preferred embodiments, variations and modifications exist within the spirit and scope of the invention as described and defined in the following claims.

1. A shower fitting comprising:
a first outlet;
a second outlet;
a bore having an inner surface and in fluid communication with the first outlet and the second outlet;
at least one inlet in fluid communication with the bore;
an aspirator having a body received within the bore, the body including a first end, a second end, an inner passageway extending between the first end and the second end, and an outer surface positioned in spaced relation to the inner surface of the bore;
an outer passageway defined intermediate the outer surface of the body and the inner surface of the bore, the outer passageway having a sealed first end, an open second end, a first cross-sectional area proximate the sealed first end and a second cross-sectional area proximate the open second end, the first cross-sectional area being greater than the second cross-sectional area; and
wherein the outer passageway opens to the bore proximate the open second end, the bore having a cross-sectional area greater than the second cross-sectional area of the outer passageway, such that a negative pressure is exerted on the inner passageway by fluid flow though the outer passageway to the second outlet.

2. The shower fitting of claim 1, wherein the first end of the body includes an end wall sealingly received within the bore thereby defining the sealed first end of the outer passageway.

3. The shower fitting of claim 1, wherein the body has a first outer diameter proximate the first end and a second outer diameter proximate the second end, the first outer diameter being less than the second outer diameter.

4. The shower fitting of claim 1, wherein the body includes a frusto-conical portion.

5. The shower fitting of claim 1, further comprising a connecting port in fluid communication with the at least one inlet and the bore, the connecting port extending radially relative to the bore and positioned adjacent the sealed first end.

6. The shower fitting of claim 1, further comprising a deflector coupled to the second end of the body and defining a radially oriented opening in fluid communication with the outer passageway and the inner passageway.

7. The shower fitting of claim 6, wherein the deflector includes a tapered surface extending radially inwardly as the surface extends axially outwardly from the second end of the body.

8. The shower fitting of claim 6, wherein the deflector includes a plurality of resilient retaining legs configured to releasably couple to the inner passageway of the body.

9. An aspirator configured to be received with a bore of a shower fitting, the aspirator comprising:
a body including a first end, a second end, an inner passageway extending axially between the first end and the second end, and an outer surface extending radially outwardly as the outer surface extends axially in a direction from the first end toward the second end;
a deflector coupled to the second end of the body and including an outer surface extending radially inwardly as the outer surface extends axially in a direction away from the body; and
an opening defined between the second end of the body and the deflector, the opening in fluid communication with the inner passageway.

10. The aspirator of claim 9, wherein an outer passageway is defined intermediate the outer surface of the body and an inner surface of the bore, the outer passageway having a sealed first end, an open second end, a first cross-sectional area proximate the sealed first end and a second cross-sectional area proximate the open second end, the first cross-sectional area being greater than the second cross-sectional area.

11. The aspirator of claim 9, wherein the first end of the body includes an end wall configured to be sealingly received within the bore.

12. The aspirator of claim 9, wherein the body has a first outer diameter proximate the first end and a second outer diameter proximate the second end, the first outer diameter being less than the second outer diameter.

13. The aspirator of claim 9, wherein the body includes a frusto-conical portion.

14. The aspirator of claim 9, wherein the deflector includes a tapered surface extending radially inwardly as the surface extends axially outwardly from the second end of the body.

15. The shower fitting of claim 9, wherein the deflector includes a plurality of resilient retaining legs configured to releasably couple to the inner passageway of the body.

16. An aspirator configured to be received with a bore of a shower fitting, the aspirator comprising:
a body including a first end, a second end, an inner passageway extending axially between the first end and the second end, and a frusto-conical portion positioned intermediate the first end and the second end;
an end wall extending radially outwardly from the first end of the body and configured to be sealingly received within the bore.

17. The aspirator of claim 16, wherein the frusto-conical portion of the body includes an outer surface extending radially outwardly as the outer surface extends axially in a direction from the first end toward the second end.

18. The aspirator of claim 17, further comprising:
a deflector coupled to the body and including an outer surface extending radially inwardly as it extends axially in a direction away from the second end of the body; and
an opening defined between the second end of the body and the deflector, the opening in fluid communication with the inner passageway.

19. The aspirator of claim 18, wherein the deflector includes a tapered surface extending radially inwardly as the surface extends axially outwardly from the second end of the body.

20. The aspirator of claim 18, wherein the deflector includes a plurality of resilient retaining legs configured to releasably couple to the inner passageway of the body.

21. The aspirator of claim 16, wherein an outer passageway is defined intermediate the outer surface of the body and an inner surface of the bore, the outer passageway having a sealed first end, an open second end, a first cross-sectional area proximate the sealed first end and a second cross-sectional area proximate the open second end, the first cross-sectional area being greater than the second cross-sectional area.

22. The aspirator of claim 16, wherein the body has a first outer diameter proximate the first end and a second outer diameter proximate the second end, the first outer diameter being less than the second outer diameter.
